(19) United States
(12) Patent Application Publication
(10) Pub. No.: US 2026/0330736 A1
(43) Pub. Date: Oct. 22, 2026

(54) METHOD AND SYSTEM FOR 3D MOTION CAPTURE

(71) Applicant: APLA INC., Seongnam-si, Gyeonggi-do (KR)

(72) Inventors: Youngsu LEE, Seoul (KR); Hyuntaek LIM, Seoul (KR); Donghyun LIM, Seoul (KR); Jaehong CHOI, Seoul (KR); Taeyoung SOHN, Seoul (KR); Kyungmoon LEE, Seoul (KR); Sungjoon PARK, Seoul (KR); Byungchan KO, Seoul (KR); Hyeokmin KWON, Seoul (KR); Woosub LEE, Seoul (KR); Chanyeong SHIN, Seoul (KR)

(21) Appl. No.: 19/114,157

(22) PCT Filed: Aug. 18, 2023
(86) PCT No.: PCT/KR2023/012256

§ 371 Date: Mar. 21, 2025

(30) Foreign Application Priority Data
Sep. 21, 2022 (KR) 10-2022-0119647
Aug. 11, 2023 (KR) 10-2023-0105729

(51) Int. Cl. G06T 13/40; G06T 7/70; G06T 17/20; G06V 10/764; G06V 40/16; G06V 40/20

(52) U.S. Cl. CPC G06T 13/40; G06T 7/70; G06T 17/20; G06V 10/764; G06V 40/161; G06V 40/23; G06V 40/28; G06T 2207/30201; G06V 2201/07

(57) ABSTRACT

A 3D motion capture method includes: receiving an input image including a person object; detecting a person region, hand regions, and a face region from at least some of the input image by using a first machine learning model; and recognizing 3D motion information from a person sub-image including the person region, hand sub-images including the hand regions, and a face sub-image including the face region. A character image, including a character that imitates the body motion, hand motion, and face motion of the person object included in the input image, is generated through rendering based on the 3D motion information.

### TECHNICAL FIELD

The present disclosure relates to method and system for 3D motion capture, and more particularly, to a method and system for recognizing the 3D motion information of a person object included in an image to generate a character image including a character that imitates the body motion, hand motion, and face motion of the person object included in the image.

### BACKGROUND ART

As interest in virtual space increases, interest in characters representing users in virtual space is also increasing. Many service providers are making considerable efforts to implement virtual 3D characters that move similarly to people in the real world.

Motion capture is a technique for generating digital characters that move similarly to animals or people in videos by using footage of actual animal or human movements. In the case of 3D motion capture, it often involves complex computation, so that a considerable amount of delay time is required when motion capture is performed. Furthermore, when motion capture is performed in real time, there are problems in that a character's movements are often unnatural or a character cannot accurately imitates the detailed movements or facial expressions of a person object because computation needs to be performed in a short period of time.

### DISCLOSURE

### Technical Problem

The present disclosure provides a 3D motion capture method, a computer-readable non-transitory storage medium having stored thereon instructions, and an apparatus (system) for solving the above problems.

### Technical Solution

The present disclosure may be implemented in various manners including a method, an apparatus (system), or a computer-readable non-transitory storage medium having recorded thereon instructions.

According to one embodiment of the present disclosure, a 3D motion capture method that is performed by at least one processor includes: receiving an input image including a person object; detecting a person region, hand regions, and a face region from at least some of the input image by using a first machine learning model; and recognizing 3D motion information from a person sub-image including the person region, hand sub-images including the hand regions, and a face sub-image including the face region; and a character image, including a character that imitates the body motion, hand motion, and face motion of the person object included in the input image, is generated through rendering based on the 3D motion information.

According to one embodiment of the present disclosure, the receiving an input image includes sequentially receiving a plurality of frame images including the person object, in response to the sequential reception of each of the plurality of frame images, the detecting and the recognizing are performed in real time for each of the plurality of frame images, and a plurality of character images, each including a character that imitates the body motion, hand motion, and face motion of the person object included in a corresponding one of the plurality of frame images, are generated through rendering based on the 3D motion information.

According to one embodiment of the present disclosure, the first machine learning model includes a hand classifier, and the detecting includes classifying the detected hand regions as at least one of a left-hand region, a right-hand region, and a both-hand region by using the hand classifier.

According to one embodiment of the present disclosure, the recognizing includes: recognizing body motion information from the person sub-image including the person region by using a second machine learning model; recognizing hand motion information from the hand sub-images including the hand regions by using a third machine learning model; and recognizing face motion information from the face sub-image including the face region by using a fourth machine learning model.

According to one embodiment of the present disclosure, the second machine learning model is a model configured to output body model parameters and camera parameters based on the person sub-image, and the body motion information includes body 3D joint angle information, body 3D joint location information, and body 3D mesh information obtained based on the body model parameters.

According to one embodiment of the present disclosure, the second machine learning model is a model further configured to further output body 2D joint estimation information and a body part segmentation map based on the person sub-image.

According to one embodiment of the present disclosure, the 3D motion capture method further includes classifying the detected hand regions as at least one of a left-hand region, a right-hand region, and a both-hand region by using the body 3D joint location information, the body 2D joint estimation information, and the body part segmentation map.

According to one embodiment of the present disclosure, the first machine learning model is a model configured to detect the person region, the hand regions, and the face region from at least some of the input image and recognize the body motion information, and the second machine learning model is the same model as the first machine learning model.

According to one embodiment of the present disclosure, receiving the input image includes sequentially receiving a plurality of frame images having the same size, in response to the sequential reception of each of the plurality of frame images, the detecting and the recognizing 3D motion information are performed in real time for each of the plurality of frame images, in the detecting and the recognizing 3D motion information for a specific one of the plurality of frame images, at least some of the specific frame image is applied as input to the first machine learning model, and the at least some of the specific frame image applied as input to the first machine learning model, when a person region is detected from a previous frame image of the specific frame image, includes a region at a location that is the same as the location of the person region detected from the previous frame image, and, when a person region is not detected from a previous frame image of the specific frame image, is all the specific frame image.

According to one embodiment of the present disclosure, the third machine learning model includes a hand classifier, and the recognizing hand motion information includes classifying the detected hand regions as at least one of a left-hand region, a right-hand region, and a both-hand region by using the hand classifier.

According to one embodiment of the present disclosure, the third machine learning model is a model configured to output hand pose parameters based on the hand sub-images, and the hand motion information includes first wrist angle information, hand 3D joint angle information, hand 3D mesh information, and camera parameters obtained based on the hand pose parameters.

According to one embodiment of the present disclosure, the body motion information includes second wrist angle information obtained based on the output of the second machine learning model, and the recognizing 3D motion information further includes correcting the second wrist angle information obtained based on the output of the second machine learning model by using the first wrist angle information obtained based on the hand pose parameters.

According to one embodiment of the present disclosure, the body motion information includes elbow angle information and shoulder angle information obtained based on the output of the second machine learning model, and the recognizing 3D motion information further includes correcting the elbow angle information and shoulder angle information obtained based on the output of the second machine learning model by using the first wrist angle information.

According to one embodiment of the present disclosure, the fourth machine learning model is a model configured to output 3D face model parameters, 3D facial landmark information, a blend shape, and camera parameters based on the face sub-image.

According to one embodiment of the present disclosure, the face motion information includes head pose information, face shape information, and face expression information, and the recognizing face motion information includes recognizing the head pose information, the face shape information, and the face expression information separately from the face sub-image by using the fourth machine learning model.

According to one embodiment of the present disclosure, the face expression information includes gaze information and tongue movement information.

According to one embodiment of the present disclosure, the body motion information includes head angle information obtained based on the output of the second machine learning model, and the recognizing 3D motion information further includes correcting the head angle information obtained based on the output of the second machine learning model by using the head pose information.

According to one embodiment of the present disclosure, the 3D motion information includes joint angle information, and the recognizing 3D motion information includes correcting the joint angle information by using at least one of the body ratio of the person object included in the input image, the body ratio of the character, and joint angle restriction information associated with the character.

There is provided a computer-readable non-transitory storage medium having recorded thereon instructions for executing the motion capture method according to one embodiment of the present disclosure on a computer.

A motion capture system according to one embodiment of the present disclosure includes memory, and at least one processor connected to the memory and configured to execute at least one computer-readable program included in the memory; the at least one program includes instructions for receiving an input image including a person object, detecting a person region, hand regions, and a face region from at least some of the input image by using a first machine learning model, and recognizing 3D motion information from a person sub-image including the person region, hand sub-images including the hand regions, and a face sub-image including the face region; and a character image, including a character that imitates the body motion, hand motion, and face motion of the person object included in the input image, is generated through rendering based on the 3D motion information.

### Advantageous Effects

According to some embodiments of the present disclosure, pieces of motion information for respective target objects may be individually recognized using a plurality of models for different target objects. Furthermore, pieces of motion information for respective target objects may be individually recognized based on a plurality of sub-images each having a large proportion for a corresponding one of the target objects. Accordingly, detailed motion information may be extracted from an image in a short period of time.

According to some embodiments of the present disclosure, object detection and body motion recognition are performed simultaneously, so that motion capture can be performed in a short time. Furthermore, detection results for a previous frame image are used for detection for a subsequent frame image, so that the amount of computation or time required for motion capture for continuously received images can be reduced.

According to some embodiments of the present disclosure, by using motion information obtained based on the output of a specific model, motion information obtained based on the output of another model is corrected or replaced, so that a character image that more accurately and naturally imitates the motion of a person object can be generated.

According to some embodiments of the present disclosure, head pose information, face shape information, and face expression information may be recognized separately. Furthermore, face expression information may include gaze information and tongue movement information. Accordingly, a character image that imitates the face expressions of a person object in more detail may be generated.

The effects of the present disclosure are not limited to the effects mentioned above, and other effects not mentioned may be clearly understood by those having ordinary skill in the art to which the present disclosure pertains (referred to as “those skilled in the art”) from the description of the claims.

### DESCRIPTION OF DRAWINGS

Embodiments of the present disclosure will be described with reference to the accompanying drawings, wherein like reference numerals denote like elements, but are not limited thereto:

FIG. 1 is a diagram showing an example in which a 3D motion capture method according to one embodiment of the present disclosure is utilized;

FIG. 2 is a block diagram showing the internal configuration of a motion capture system (200) according to one embodiment of the present disclosure;

FIG. 3 is a schematic diagram showing an example of a 3D motion capture method according to one embodiment of the present disclosure;

FIG. 4 is a diagram showing an example of an input image including a person object according to one embodiment of the present disclosure;

FIG. 5 is a diagram showing an example in which a motion capture system according to one embodiment of the present disclosure detects a person region, hand regions, and a face region from an input image;

FIG. 6 is a diagram showing an example in which a motion capture system according to one embodiment of the present disclosure recognizes body motion information from a person sub-image including a person region;

FIGS. 7 and 8 are diagrams showing examples in which a motion capture system according to one embodiment of the present disclosure performs detection and body motion information recognition by using the same model;

FIG. 9 is a diagram showing an example in which a motion capture system according to one embodiment of the present disclosure recognizes hand motion information from hand sub-images including hand regions;

FIG. 10 is a diagram showing an example in which a motion capture system according to one embodiment of the present disclosure recognizes face motion information from a face sub-image including a face region;

FIG. 11 is a diagram showing an example in which rendering is performed based on the motion information according to one embodiment of the present disclosure;

FIG. 12 is a diagram showing an example of a character image including a character that imitates the motion of a person object according to one embodiment of the present disclosure; and

FIG. 13 is a flowchart illustrating an example of a 3D motion capture method according to one embodiment of the present disclosure.

### MODE FOR INVENTION

Specific details for the implementation of the present disclosure will be described in detail below with reference to the accompanying drawings. However, in the following description, when there is a concern that the gist of the present disclosure may be unnecessarily obscured, specific descriptions of widely known functions or configurations will be omitted.

In the accompanying drawings, identical or corresponding components are given the same reference numerals. Furthermore, in the following description of embodiments, redundant descriptions of identical or corresponding components may be omitted. However, even when a description of a component is omitted, it is not intended that the component is not included in any embodiment.

The advantages and features of disclosed embodiments and methods for achieving them will become apparent with reference to the embodiments to be described below together with the accompanying drawings. However, the present disclosure is not limited to the embodiments to be disclosed below and may be implemented in various different forms. These embodiments are provided merely to make the present disclosure complete and to fully inform those skilled in the art of the scope of the invention.

The terms used herein are briefly described, and then the disclosed embodiments are specifically described. Widely used general terms are selected as the terms used herein as much as possible by taking into consideration their functions in the present disclosure, but they may vary depending on the intention of engineers in the relevant field, precedents, the emergence of new technologies, and/or the like. Furthermore, in a specific case, there is a term that is selected by the applicant as desired, in which case the meaning thereof will be described in detail in the relevant part of the description of the invention. Accordingly, the terms used herein should be defined based on the meanings of the terms and the overall content of the present disclosure, not simply the names of the terms.

In the present specification, a singular expression includes a plural expression unless the context clearly specifies that it is singular. Furthermore, a plural expression includes a singular expression unless the context clearly specifies that it is plural. Throughout the specification, when a part is described as including a specific component, this does not mean that another component is excluded, but rather that another component may be included, unless otherwise specifically stated.

Furthermore, the term ‘module’ or ‘part’ used herein refers to a software or hardware component. The ‘module’ or ‘part’ performs a specific role. However, the ‘module’ or ‘part’ is not limited to software or hardware. The ‘module’ or ‘part’ may be configured to be present on an addressable storage medium, and may be configured to play back one or more processors. Accordingly, as an example, the ‘module’ or ‘part’ may include at least one of components such as software components, object-oriented software components, class components and task components, processes, functions, attributes, procedures, subroutines, segments of program code, drivers, firmware, microcode, circuitry, data, databases, data structures, tables, arrays, and variables. Components and ‘modules’ or ‘parts’ may be combined into a smaller number of components and a smaller number of ‘modules’ or ‘parts’, or may be further separated into additional components and additional ‘modules’ or ‘parts’ in terms of functionality provided therein.

According to one embodiment of the present disclosure, the ‘module’ or ‘part’ may be implemented as a processor and memory. The ‘processor’ should be broadly construed to include a general purpose processor, a central processing unit (CPU), a microprocessor, a digital signal processor (DSP), a controller, a microcontroller, a state machine, and the like. In some environments, the ‘processor’ may also refer to an application specific integrated circuit (ASIC), a programmable logic device (PLD), a field programmable gate array (FPGA), and the like. The ‘processor’ may also refer to a combination of processing devices, such as, for example, a combination of a DSP and a microprocessor, a combination of multiple microprocessors, a combination of one or more microprocessors in combination with a DSP core, or any other such combination of configurations. The ‘memory’ should also be broadly construed to include any electronic component capable of storing electronic information. The ‘memory’ may also refer to various types of processor-readable media, such as random access memory (RAM), read-only memory (ROM), non-volatile random access memory (NVRAM), programmable read-only memory (PROM), erasable programmable read-only memory (EPROM), electrically erasable PROM (EEPROM), flash memory, magnetic or optical data storage, registers, etc. The memory is described as being in electronic communication with a processor when the processor can read information from the memory and/or write information to the memory. The memory integrated in a processor is in electronic communication with the processor.

In the present disclosure, the ‘system’ may include at least one of a server device and a cloud device, but is not limited thereto. For example, the system may be composed of one or more server devices. As another example, the system may be composed of one or more cloud devices. As still another example, the system may be configured such that a server device and a cloud device may be configured and operated together.

In the present disclosure, the ‘machine learning model’ may include any model used to infer an answer to a given input. According to one embodiment, the machine learning model may include an artificial neural network model including an input layer, a plurality of hidden layers, and an output layer. In this case, each layer may include a plurality of nodes. Furthermore, in the present disclosure, the machine learning model may refer to an artificial neural network model, and the artificial neural network model may refer to a machine learning model.

In the present disclosure, ‘each of a plurality of As’ or ‘a plurality of As each’ may refer to each of all components included in the plurality of As, or may refer to each of some components included in the plurality of As.

In the present disclosure, the ‘person’ or ‘person object’ may encompass not only persons but also all objects that can operate in the real or virtual world, such as animals. Furthermore, in some embodiments of the present disclosure, the ‘person’ or ‘person object’ may also refer to a region in an image where a person or person object is captured or a region where a person or person object is detected from an image.

In some embodiments of the present disclosure, the ‘image’ may include not only one image but also a plurality of images. For example, an image may include a video including a plurality of frame images.

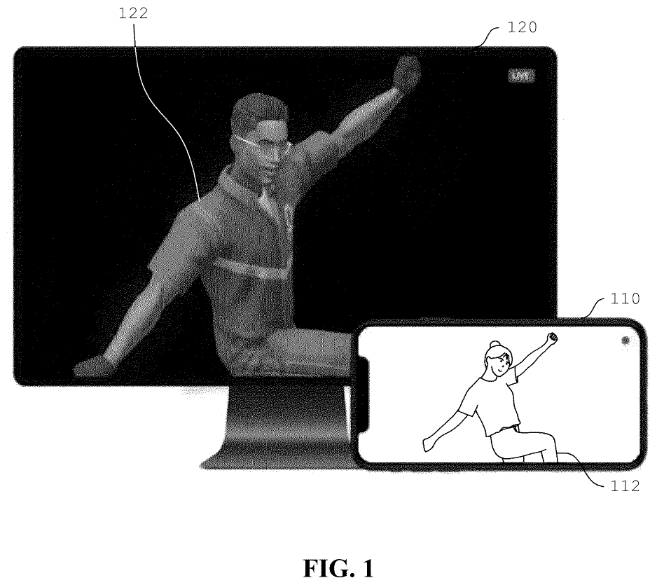

FIG. 1 is a diagram showing an example in which a 3D motion capture method according to one embodiment of the present disclosure is utilized. According to one embodiment, a user may capture a person object 112 (e.g., a user) in motion by using a user terminal (e.g., a first user terminal 110). The user terminal may include, but is not limited to, a mobile device (e.g., a smartphone, a tablet PC, or the like), a webcam device with processing capabilities (e.g., a webcam device including a processor chip, or the like), a desktop PC, etc. Although the person object 112 included in a captured image is illustrated as being replaced with an illustration in the example of FIG. 1, this is intended only for illustrative purposes. In an actual implementation, the captured image may be an image of an actual person performing a specific motion.

The user terminal may recognize the motion information of the person object 112 included in the captured image. For example, the motion information may be 3D motion information, and may include body motion information, hand motion information, and face motion information. According to one embodiment, the body motion information, the hand motion information, and the face motion information may be recognized by separate models. A character image 122, including a character that imitates the body motion, hand motion, and face motion of the person object 112 included in the image, may be generated through rendering based on the recognized motion information.

A user terminal (e.g., a second user terminal 120) may output the generated character image 122. Although the person object 112 is illustrated as being captured by the first user terminal 110 and the character image 122 is illustrated as being output by the second user terminal 120 in the example of FIG. 1, this is intended only for convenience of illustration, and the present disclosure is not limited thereto. One or more of the tasks of capturing the person object 112, recognizing motion information, rendering, and outputting the character image 122 may be performed by the same device, or the individual tasks may be performed by separate devices. For example, an image or video captured by a first device may be transmitted to a second device, motion information recognition for the image or video may be performed by the second device, and the recognized motion information may be transmitted to a third device and rendered by the third device. In one embodiment, when the image including the person object 112 is captured and the generated character image 122 is output via the same user terminal, the captured image and the character image 122 imitating the motion of the person object 112 included in the image may be simultaneously output onto split screens of the display of the user terminal.

Additionally, the user terminal may provide a user interface (e.g., a GUI) (not shown) that can utilize the character image 122. For example, the generated character image 122 may be utilized in various fields requiring motion capture, such as streaming broadcasting, video production, animation production, game motion production, and webtoon production, and the user terminal may provide an appropriate user interface suitable for the purpose.

In some embodiments of the present disclosure, at least one device that performs at least one task (e.g., at least one of tasks such as capturing the person object 112, recognizing motion information, correcting motion information, rendering, and outputting the character image 122) for performing the motion capture method of the present disclosure may be referred to as a motion capture system.

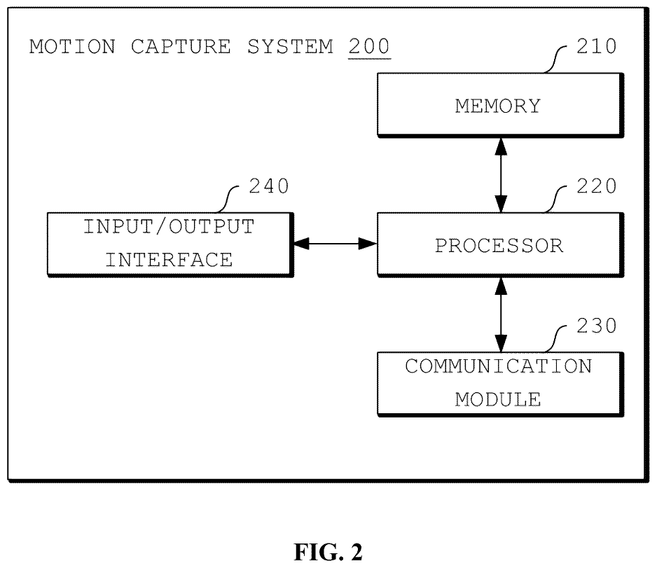

FIG. 2 is a block diagram showing the internal configuration of a motion capture system 200 according to one embodiment of the present disclosure. The motion capture system 200 may include memory 210, a processor 220, a communication module 230, and an input/output interface 240. The motion capture system 200 may be configured to communicate information and/or data over a network by using the communication module 230.

The memory 210 may include any non-transitory computer-readable storage medium. According to one embodiment, the memory 210 may include a permanent mass storage device such as read only memory (ROM), a disk drive, a solid state drive (SSD), or flash memory. As another example, a permanent mass storage device such as ROM, an SSD, flash memory, or a disk drive may be included in the motion capture system 200 as a separate permanent storage device distinct from memory. Furthermore, the memory 210 may store an operating system and at least one program code (e.g., a code for object detection, motion recognition, etc. installed and operated in the motion capture system 200).

These software components may be loaded from a computer-readable storage medium separate from the memory 210. This separate computer-readable storage medium may include storage media directly connectable to the motion capture system 200. For example, the separate computer-readable storage medium may include storage media such as a floppy drive, a disk, a tape, a DVD/CD-ROM drive, and a memory card. As another example, the software components may be loaded into the memory 210 via the communication module 230, rather than from a computer-readable storage medium. For example, at least one program may be loaded into the memory 210 based on a computer program (e.g., a program for object detection, motion recognition, etc.) that is installed by files provided by developers or a file distribution system for distributing installation files of applications via the communication module 230.

The processor 220 may be configured to process instructions of a computer program by performing basic arithmetic, logic, and input/output operations. The instructions may be provided to a user terminal (not shown) or another external system by the memory 210 or the communication module 230. For example, the processor 220 may receive an input image including a person object, and may detect a person region, hand regions, and a face region from at least some of the input image by using a first machine learning model. Furthermore, the processor 220 may recognize 3D motion information from a person sub-image including a person region, hand sub-images including hand regions, and a face sub-image including a face region. According to one embodiment, the processor 220 may sequentially receive a plurality of frame images including a person object, and may perform detection and motion information recognition for each of the plurality of frame images in response to the sequential reception of each of the plurality of frame images.

The communication module 230 may provide a configuration or function for enabling the motion capture system 200 to communicate with an external device or the like over a network, and may provide a configuration or function for enabling the motion capture system 200 to communicate with an external system (e.g., a separate cloud system or the like). As an example, control signals, instructions, data, etc. provided under the control of the processor 220 of the motion capture system 200 may be transmitted to the external device and/or the external system through the communication module of the external device and/or the external system via the communication module 230 and the network.

In addition, the input/output interface 240 of the motion capture system 200 may be a means for interfacing with a device (not shown) for input or output that may be connected to the motion capture system 200 or that may be included in the motion capture system 200. Although the input/output interface 240 is illustrated as an element constructed separately from the processor 220 in FIG. 2, it is not limited thereto, but may be constructed to be included in the processor 220. The motion capture system 200 may include more components than the components of FIG. 2. However, it is not necessary to clearly illustrate most of the conventional components.

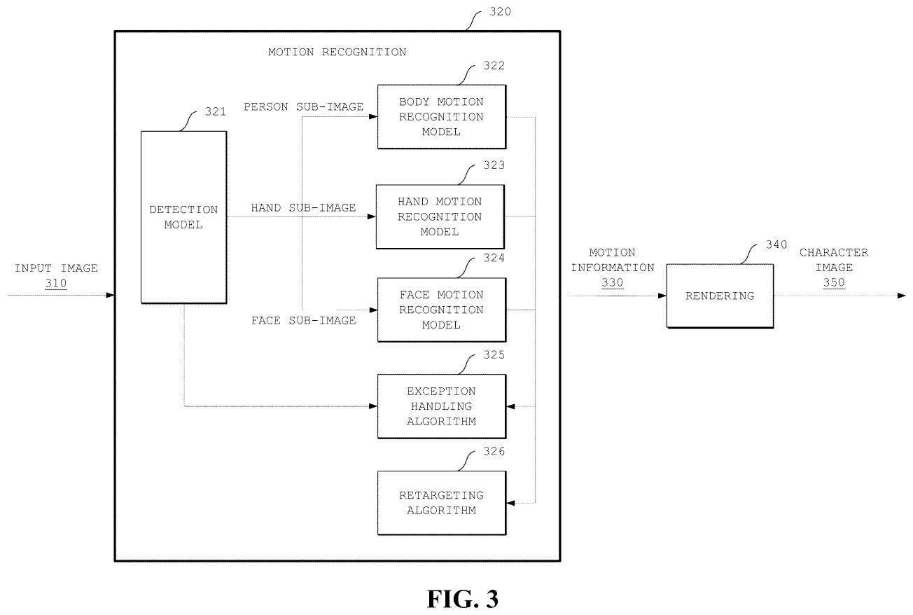

FIG. 3 is a schematic diagram showing an example of a 3D motion capture method according to one embodiment of the present disclosure.

According to one embodiment, the motion capture system may extract motion information 330 by receiving an input image 310 including a person object and performing motion recognition 320 on the input image 310.

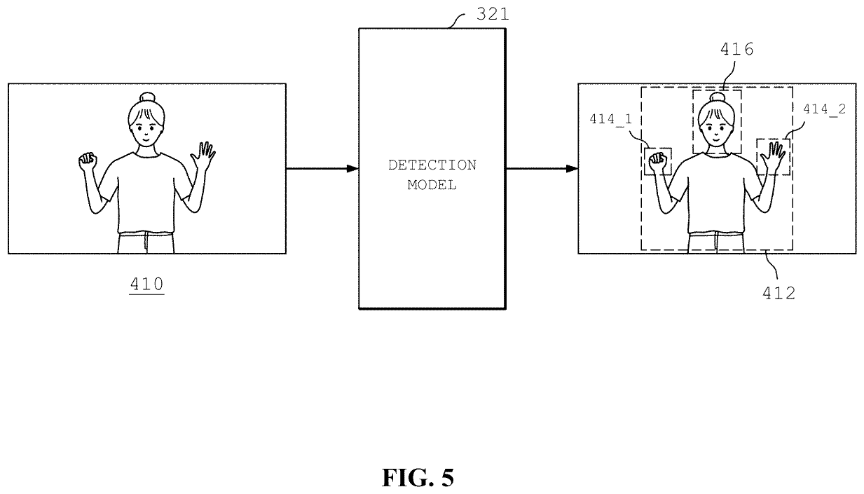

For example, the motion capture system may first detect a person region, hand regions, and a face region from at least some of the input image 310 by using a detection model 321. This will be described in more detail later with reference to FIG. 5.

Thereafter, the motion capture system may recognize motion information 320 from a person sub-image including the detected person region, hand sub-images including the detected hand regions, and a face sub-image including the detected face region.

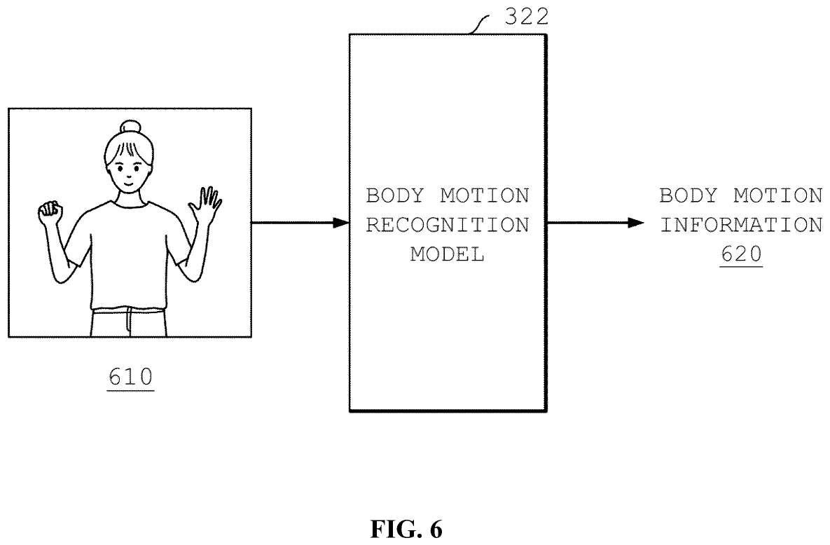

For example, the motion capture system may recognize body motion information from the person sub-image by using a body motion recognition model 322. Furthermore, the motion capture system may recognize hand motion information from the hand sub-images by using a hand motion recognition model 323. Moreover, the motion capture system may recognize face motion information from the face sub-image by using a face motion recognition model 324. In this manner, detailed motion information 330 may be extracted from an image in a short period of time by separately recognizing pieces of motion information for respective objects based on a plurality of sub-images in each of which a corresponding one of the target objects has a large proportion by using a plurality of models having different target objects. A specific example in which the motion capture system performs the motion recognition 320 will be described in more detail later with reference to FIGS. 6 to 10.

According to one embodiment, the motion capture system may correct at least some of the recognized motion information and/or supplement the motion information by using an exception handling algorithm 325. For example, the exception handling algorithm 325 may be an algorithm that corrects and/or supplements the motion information so that a character naturally assumes a default motion (e.g., a default pose) or maintains the motion or pose of a previous frame in a character image 350 to be generated when a specific body part (e.g., a hand or the like) of a person object in the input image 310 moves out of a screen, a person object moves rapidly and becomes blurred, the distinction between right and left hands fails, or there is a problem with detection and/or motion recognition for any other reason. Additionally, the motion capture system may apply a smoothing algorithm to at least some of the recognized motion information (e.g., joint angle information or the like) to avoid an abrupt pose change and implement a natural motion during exception handling.

In the case where the body ratio of the person object included in the input image 310 is different from the body ratio of a target character to be included in the character image 350, when the motion information of the person object in the image 310 is directly applied to the character, there are cases where the character imitating the motion of the person object cannot be appropriately implemented. Accordingly, according to one embodiment, the motion capture system may correct at least some of the motion information by using a retargeting algorithm 326.

For example, when a person object in an image makes a clapping motion, a character may not clap its hands in the case where the joint angle of the person object is applied to a character having a different body ratio without change.

Accordingly, the motion capture system may correct the joint angle information by using at least one of the body ratio of the person object included in the input image 310 and the body ratio of the character so that the character can appropriately imitate the motion of the person object.

As another example, in the case where the head of a character is excessively large, when a person object in the input image 310 raises its arm, there may occur inter-penetration in which the character's arm penetrates the head in the generated character image 350. To prevent the inter-penetration phenomenon, the motion capture system may correct joint angle information by using joint angle restriction information associated with a character.

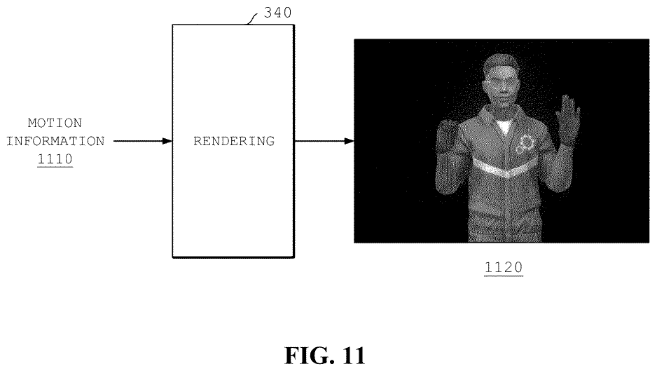

As described above, the motion information 330 may be extracted from the input image 310 through a series of motion recognition (320) processes. Based on the extracted motion information 330, rendering 340 may be performed, and accordingly, the character image 350 including the character imitating the motion of the person object included in the input image 310 may be generated. A specific example of performing the rendering 340 based on the motion information 330 will be described in more detail later with reference to FIG. 11.

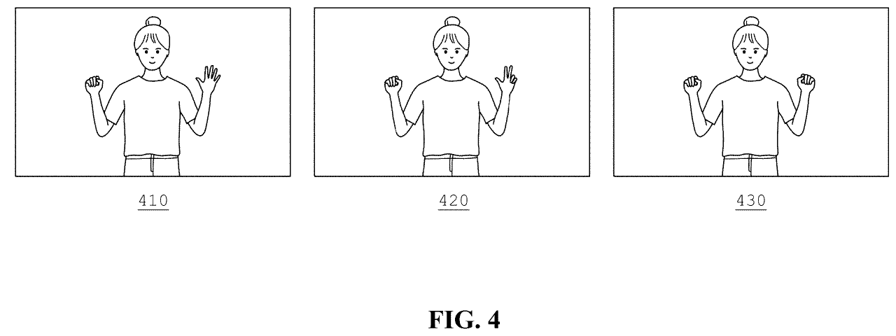

FIG. 4 is a diagram showing an example of an input image including a person object according to one embodiment of the present disclosure. In the example of FIG. 4, the person object included in the input image is illustrated as being replaced with an illustration instead, but this is intended only for illustrative purposes. In an actual implementation, the input image may be an image in which an actual person performs a specific motion.

The motion capture system may receive an input image including a person object. For example, it may receive an image or video captured in real time via a camera, or may receive it by loading or decoding a previously captured image or video.

According to one embodiment, the motion capture system may sequentially receive a plurality of frame images 410, 420, and 430 including a person object.

For example, a user may capture an image in which a person object, while making a specific facial expression in the state of standing while facing the front of a camera, performs a motion that starts with the pose of making a fist with one hand and extending all the fingers of the other hand and ends with the pose of sequentially folding the fingers of the extended hand and forming all the fingers of the hand into a fist.

Accordingly, there may be sequentially captured a first frame image 410 in which a person object assumes the pose of making a fist with one hand and extending all the fingers of the other hand while making a specific facial expression in the state of standing and facing the front of a camera, a second frame image 420 in which the person object assumes the pose of making a fist with one hand, folding some fingers of the other hand and extending the other fingers of the other hand while making a specific facial expression in the state of standing and facing the front of a camera, and a third frame image 430 in which the person object assumes the pose of making fists with both hands while making a specific facial expression in the state of standing and facing the front of a camera.

The motion capture system may sequentially receive the first frame image 410, the second frame image 420, and the third frame image 430. For example, the motion capture system may sequentially receive the first to third frame images 410, 420, and 430 that are captured in real time. As another example, the motion capture system may sequentially receive the first to third frame images 410, 420, and 430 by loading or decoding previously captured images. In one embodiment, the motion capture system may also receive metadata, including frame numbers or the like indicative of the sequential positions of the first to third frame images 410, 420, and 430, together with the images.

The motion capture system may perform the motion information recognition process, to be described below, in real time for each of the plurality of frame images 410, 420, and 430 in response to the sequential reception of each of the plurality of frame images 410, 420, and 430.

FIG. 5 is a diagram showing an example in which a motion capture system according to one embodiment of the present disclosure detects a person region 412, hand regions 414_1 and 414_2, and a face region 416 from an input image.

In one embodiment, the motion capture system may detect the person region 412, the hand regions 414_1 and 414_2, and the face region 416 from a first frame image 410 by using a detection model 321. In one embodiment, the detection model 321 may be a machine learning model (e.g., a deep learning-based network). For example, the detection model 321 may be a machine learning model configured to output a bounding box 412 including a person region included in an input image, bounding boxes 414_1, and 414_2 including hand regions, and a bounding box 416 including a face region based on the input image.

Additionally, the detection model 321 may include a hand classifier. In this embodiment, the motion capture system may classify the detected hand regions 414_1 and 414_2 as at least one of a left-hand region, a right-hand region, and a both-hand region by using the detection model 321 including the hand classifier. For example, the detection model 321 may be a model configured to further output whether each of the bounding boxes 414_1 and 414_2 including hand regions includes the left hand, the right hand, or both hands.

FIG. 6 is a diagram showing an example in which a motion capture system according to one embodiment of the present disclosure recognizes body motion information 620 from a person sub-image 610 including a person region. The motion capture system may recognize body motion information 620 from a person sub-image 610 including a person region by using a body motion recognition model 322. The body motion recognition model 322 may be a machine learning model (e.g., a deep learning-based network). Furthermore, the person sub-image 610 may be a sub-image obtained by loosely cropping a first frame image so that a person region detected by the detection model is included therein.

According to one embodiment, the body motion information 620 may include body 3D joint angle information, body 3D joint location information, body 3D mesh information, and camera parameters. In this case, the joint may include, but is not limited to, the head, the neck, the shoulders, the elbows, the wrists, the finger joints, the pelvis, the knees, the ankles, and the toe joints. According to one embodiment, the body motion recognition model 322 may be a model configured to output body model parameters (e.g., skinned multi-person linear model parameters (SMPL parameters)) and camera parameters based on the person sub-image 610. Furthermore, at least some of the body motion information 620 may be obtained based on the body model parameters and/or camera parameters output by the body motion recognition model 322. Additionally, the motion capture system may obtain the coordinate information of joints in an image by re-projecting at least some (e.g., 3D joint angle information, body 3D joint location information, and/or the like) of the recognized body motion information 620 onto the image.

Additionally, the body motion information 620 may further include 2D joint estimation information and a human part segmentation map. For example, the body motion recognition model 322 may be a model configured to further output body 2D joint estimation information and a human part segmentation map based on the person sub-image 610. In this embodiment, the motion capture system may classify hand regions, detected by the detection model, as at least one of a left-hand region, a right-hand region, and a both-hand region by using body 3D joint location information, body 2D joint estimation information, and body part segmentation map.

According to one embodiment, the motion capture system may apply a smoothing algorithm to at least some (e.g., 3D joint angle information, camera parameters, and/or the like) of the body motion information 620 to prevent jitters from occurring when the body motion information 620 is applied to a character.

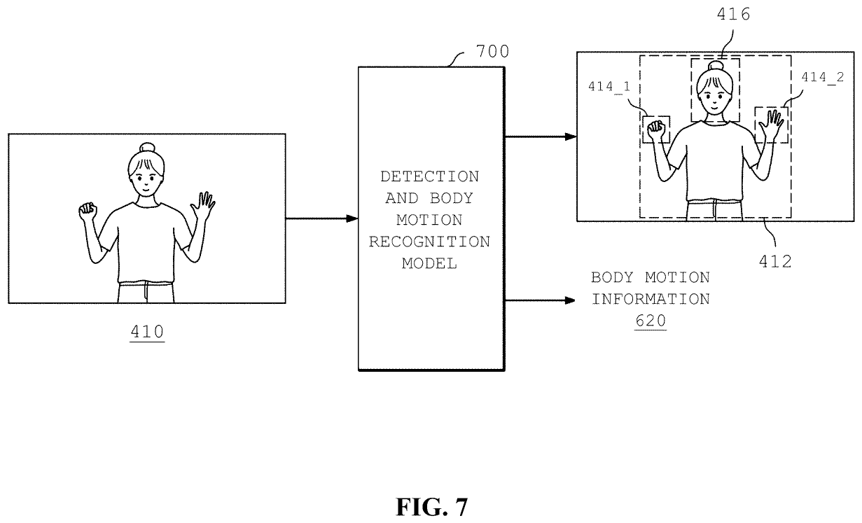

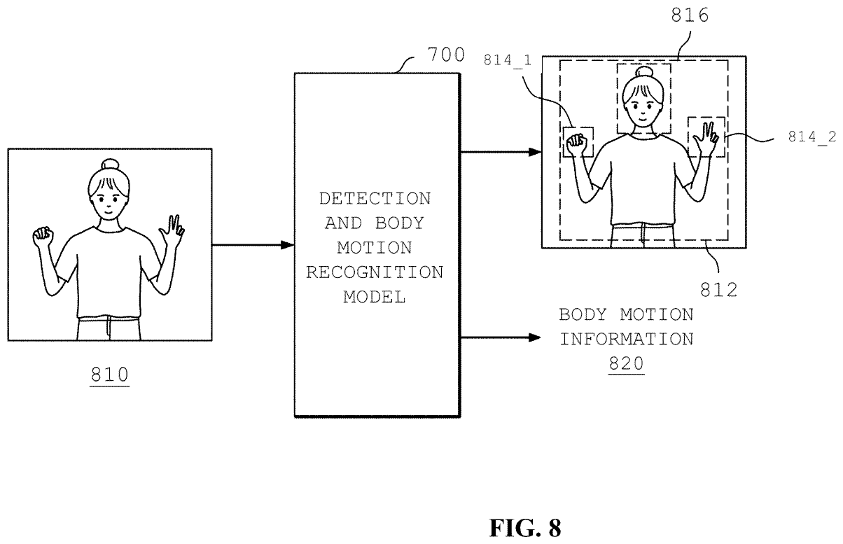

FIGS. 7 and 8 are diagrams showing examples in which a motion capture system according to one embodiment of the present disclosure performs detection and body motion information recognition by using the same model. According to one embodiment, the motion capture system may perform detection and body motion information recognition simultaneously by using the same machine learning model instead of performing detection and body motion information recognition by using separate models. For example, by using a detection and body motion recognition model 700, the motion capture system may detect a person region 412, hand regions 414_1 and 414_2, and a face region 416 from a first frame image 410 and recognize body motion information 620. In this case, the detection and body motion recognition model 700 may be a machine learning model configured to detect the person region 412, the hand regions 414_1 and 414_2, and the face region 416 from at least some of an input image and recognize the body motion information 620. For example, the detection and body motion recognition model 700 may be a deep learning-based network, but is not limited thereto.

When the motion capture system sequentially receives a plurality of frame images, the input to the detection and body motion recognition model 700 may be determined based on detection results from a previous frame image. For example, the motion capture system may detect a person region 812, hand regions 814_1 and 814_2, and a face region 816 for a second frame image, and may apply at least some 810 of the second frame image as the input to the detection and body motion recognition model 700 to recognize body motion information 820. In this case, the image applied as the input to the detection and body motion recognition model 700 may be determined based on whether the person region 412 is detected from the first frame image 410, which is the previous frame image of the second frame image.

For example, when the person region 412 is detected from the first frame image 410, the motion capture system may apply a sub-image 810 including a region at the same location as the person region detected from the first frame image 410 out of the second frame image (for example, an image obtained by loosely cropping a region at the same location as the person region detected from the first frame image 410 out of the second frame image) as the input to the detection and body motion recognition model 700. In contrast, when the person region 412 is not detected from the first frame image 410, the motion capture system may apply the overall second frame image as the input to the detection and body motion recognition model 700. Via this configuration, the motion capture system may perform motion capture at a faster speed for continuously received images.

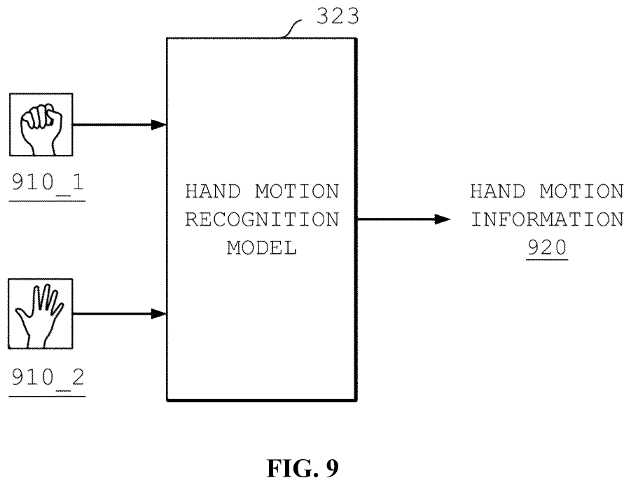

FIG. 9 is a diagram showing an example in which a motion capture system according to one embodiment of the present disclosure recognizes hand motion information 920 from hand sub-images 910_1 and 910_2 including hand regions. The motion capture system may recognize the hand motion information 920 from the hand sub-images 910_1 and 910_2 including the hand regions by using the hand motion recognition model 323. The hand motion recognition model 323 may be a machine learning model (e.g., a deep learning-based network).

In one embodiment, the hand sub-images 910_1 and 910_2 may be sub-images obtained by loosely cropping a first frame image to include the hand regions detected by the detection model (or the detection and body motion recognition model). Although the first hand sub-image 910_1 including one hand and the second hand sub-image 910_2 including the other hand are shown as being applied as separate inputs in the example of FIG. 9, the present disclosure is not limited thereto. For example, a single hand sub-image including both hands (e.g., a hand sub-image including both hands at the moment when a person object makes a clap) may be applied as the input.

According to one embodiment, the hand motion information 920 may include first wrist angle information, hand 3D joint angle information, hand 3D mesh information, and camera parameters. In one embodiment, the hand motion recognition model 323 may be a model configured to output hand pose parameters (e.g., parameters representing 3D hand poses, or more specifically, hand Model with Articulated and Non-rigid defOrmations parameters (MANO parameters)) based on the hand sub-images 910_1 and 910_2. At least some of the hand motion information 920 may be obtained based on hand pose parameters output by the hand motion recognition model 323.

According to one embodiment, the body motion information may include second wrist angle information, elbow angle information, and shoulder angle information obtained based on the output of the body motion recognition model (or the detection and body motion recognition model). The first wrist angle information is obtained based on the hand sub-images 910_1 and 910_2 having a large hand proportion out of images, and is obtained based on the output (hand pose parameters) of the hand motion recognition model 323 configured to recognize only the hand motion information 920, so that it may have higher accuracy than the second wrist angle information. Accordingly, in this embodiment, the motion capture system may correct or replace the second wrist angle information included in the body motion information by using the first wrist angle information. Additionally or alternatively, the motion capture system may correct the elbow angle information and shoulder angle information included in the body motion information by using the first wrist angle information having high accuracy, thereby allowing the body and the hands to have a natural pose that is well-harmonized in terms of the human body structure.

Additionally, the hand motion recognition model 323 may include a hand classifier. In this embodiment, by using the hand motion recognition model 323 including the hand classifier, the motion capture system may determine whether a hand is included in the hand sub-images 910_1 and 910_2 and/or classify the hand included in the hand sub-images 910_1 and 910_2 as at least one of the left hand, the right hand, and both hands.

According to one embodiment, the motion capture system may apply a smoothing algorithm to at least some (e.g., hand 3D joint angle information, wrist angle information, and/or the like) of the hand motion information 920 to prevent jitters from occurring when the hand motion information 920 is applied to a character.

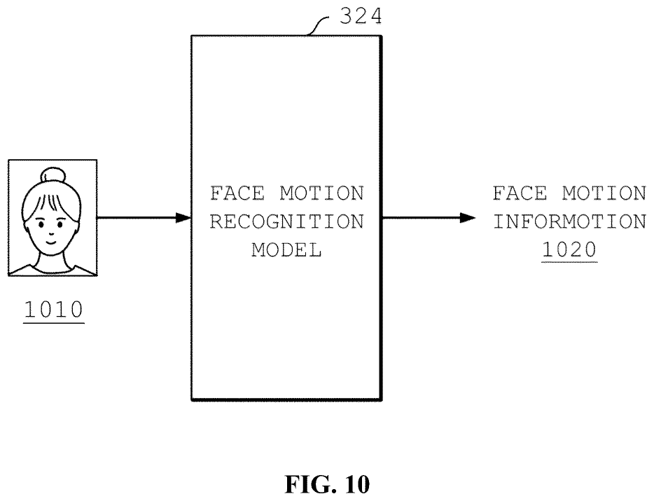

FIG. 10 is a diagram showing an example in which a motion capture system according to one embodiment of the present disclosure recognizes face motion information 1020 from a face sub-image 1010 including a face region. The motion capture system may recognize the face motion information 1020 from the face sub-image 1010 including the face region by using the face motion recognition model 324. The face motion recognition model 324 may be a machine learning model (e.g., a deep learning-based network).

In one embodiment, the face sub-image 1010 may be a sub-image obtained by loosely cropping a first frame image to include a face region detected by the detection model (or the detection and body motion recognition model). According to one embodiment, the motion capture system may perform face alignment preprocessing on the face sub-image 1010. For example, the motion capture system may receive a plurality of facial landmarks (e.g., the eye corners, the eyebrows, the nose, the mouth, and the chin) as input and perform face alignment preprocessing. The image on which the face alignment preprocessing has been performed may be applied as the input to the face motion recognition model 324. Alternatively, the face motion recognition model 324 may perform the face alignment preprocessing.

The face motion information 1020 may include first head pose information, face shape information, and face expression information. In this case, the face expression information may include gaze information and tongue movement information. For example, the face motion recognition model 324 may be a model configured to output 3D face model (e.g., 3D morphable model (3DMM) such as FaceScape;) parameters, 3D facial landmark information, a blend shape (e.g., a blend shape based on facial action units (FACS) that enable a 3D character to express a facial expression), and camera parameters based on the face sub-image 1010. At least some of the face motion information 1020 may be obtained based on the output of the face motion recognition model 324. In one embodiment, the face motion recognition model 324 may be a model trained to recognize head pose information, face shape information, and face expression information separately. Accordingly, the motion capture system may recognize the head pose information, the face shape information, and the face expression information separately.

According to one embodiment, the body motion information may include second head pose information obtained based on the output of the body motion recognition model (or the detection and body motion recognition model). The first head pose information may be obtained based on the face sub-image 1010 having a large face proportion out of images, and may be obtained based on the output of the face motion recognition model 324 configured to recognize only the face motion information 1020, so that it may have higher accuracy than the second head pose information. Accordingly, in this embodiment, the motion capture system may correct or replace the second head pose information, included in the body motion information, by using the first head pose information.

According to one embodiment, the motion capture system may apply a smoothing algorithm to at least some (e.g., 3D facial landmark information, head pose information, face shape information, face expression information, and/or the like) of the face motion information 1020 to prevent jitters from occurring when the face motion information 1020 is applied to a character.

FIG. 11 is a diagram showing an example in which rendering 340 is performed based on motion information 1110 according to one embodiment of the present disclosure. The rendering 340 may be performed by the same device as motion recognition, or may be performed by a different device.

According to one embodiment, the rendering 340 may be performed by the same device as motion recognition. For example, when the motion recognition and the rendering 340 are performed by the same program (or the same process) within the same device, separate communications may not be required. In contrast, when the motion recognition and the rendering 340 are performed within the same device but by separate programs (or separate processes), the motion information 1110 may be transmitted using an inter-process communication (IPC) method.

Alternatively, the rendering 340 may be performed by a device different from a device that performs the motion recognition. For example, the motion recognition may be performed by a first device, and the rendering 340 may be performed by a second device. In this case, the motion information 1110 may be transmitted to the second device by using any wired/wireless communication method between devices (e.g., USB communication, Wi-Fi wireless communication, socket communication using a LAN cable, or the like).

When the motion information 1110 is transmitted to another device, another program, or another process by using any communication method, the motion information 1110 may be transmitted in parallel to a plurality of threads or processes for the purpose of efficient transmission according to one embodiment. Additionally or alternatively, metadata, including frame numbers or the like indicative of the sequence of the motion information 1110, may be transmitted together with the motion information 1110. Additionally or alternatively, the motion information 1110 may be transmitted in an encrypted form so that other users cannot access the motion information 1110. When the motion information 1110 is transmitted in an encrypted form, a device (or a program) performing the rendering 340 may decrypt the motion information 1110 and then perform the rendering 340.

According to one embodiment, a character image 1120, including a character that imitates the body motion, hand motion, and face motion of a person object included in a first frame image, may be generated through the rendering 340 based on the motion information 1110. For example, a 3D character that performs the same motion as the person object may be generated through the rendering 340 based on the motion information 1110, received in real time, by using a 3D engine (e.g., Unity, Unreal Engine, or the like). The rendering 340 may be performed in a manner in which a character is fixed and a camera moves within a rendering engine, or may be performed in a manner in which a camera is fixed and a character moves.

According to one embodiment, the rendering 340 may be performed by reflecting therein not only the motion of a character but also the location and size thereof in space. Additionally, depending on the direction (e.g., the portrait or landscape) of a display onto which the character image 1120 is to be output, the field of view (e.g., a FoV value or the like) may be dynamically adjusted such that the character (or the character image 1120) may be enlarged or reduced.

Additionally, a background scene of the character image 1120 may be generated through the rendering 340. For example, the background scene may be the same as/similar to a background scene included in the first frame image. As another example, the background scene may be different from the background scene included in the first frame image, and may be a default background scene or a background scene selected by a user.

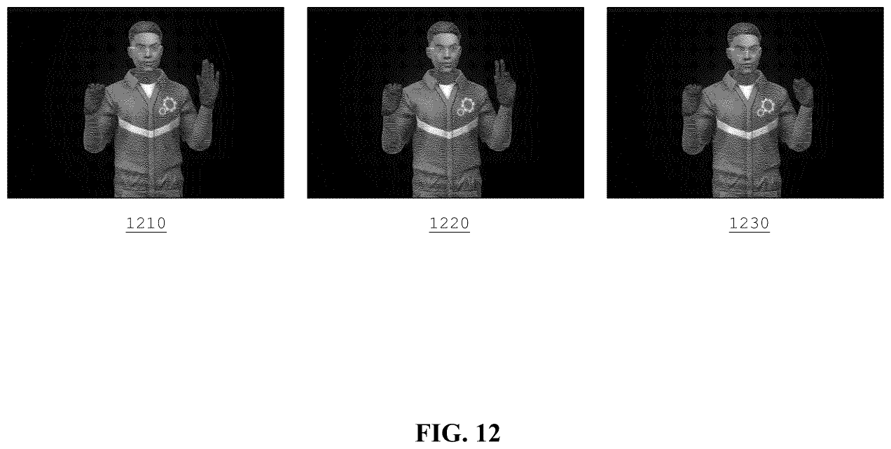

FIG. 12 is a diagram showing an example of a character image including a character that imitates the motion of a person object according to one embodiment of the present disclosure. Through a motion recognition process and a rendering process such as those of the examples described above, a first character image 1210, including a character that imitates the motion of a person object included in a first frame, may be generated.

In one embodiment, when the motion capture system sequentially receives a plurality of frame images including a person object, a plurality of character images for the plurality of frame images may be sequentially generated. For example, when the motion capture system sequentially receives a first frame image, a second frame image, and a third frame image, there may be sequentially generated a first character image 1210 including a character that imitates the motion of a person object included in the first frame image, a second character image 1220 including a character that imitates the motion of a person object included in the second frame image, and a third character image 1230 including a character that imitates the motion of a person object included in the third frame image.

According to one embodiment, the generated character image may be output to a user terminal. For example, the first character image 1210, the second character image 1220, and the third character image 1230 may be sequentially output to the user terminal. The user terminal to which the character image is output may be the same as or different from a user terminal by which the image including the person object is captured. In one embodiment, when the image including the person object is captured via the same user terminal and the generated character image is output, the captured image and the character image imitating the motion of the person object included in the image may be simultaneously output to the split screens of the display of the user terminal, respectively.

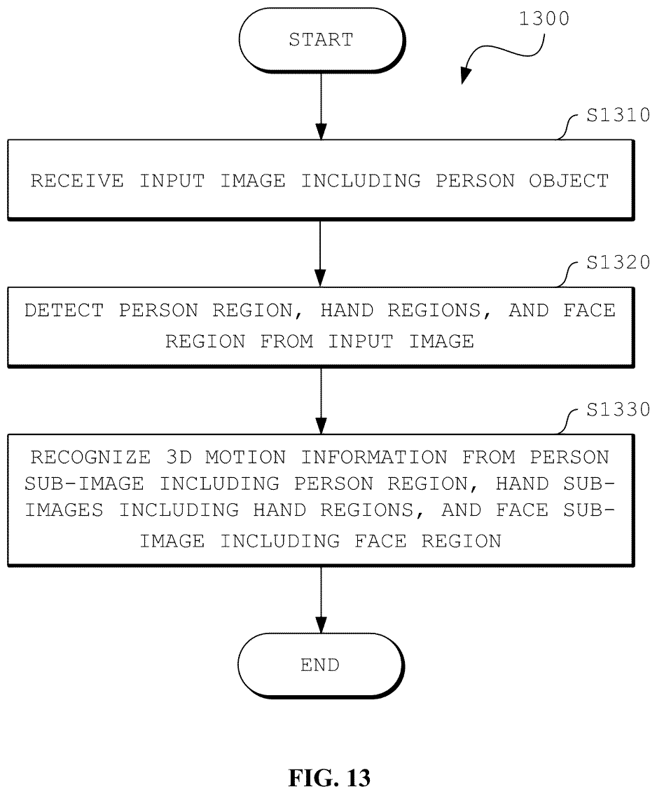

FIG. 13 is a flowchart illustrating an example of a 3D motion capture method 1300 according to one embodiment of the present disclosure. The method 1300 may be initiated in a manner in which at least one processor (e.g., at least one processor of a motion capture system) receives an input image including a person object in step S1310.

Thereafter, the processor may detect a person region, hand regions, and a face region from at least some of the input image by using a first machine learning model in step S1320.

According to one embodiment, the first machine learning model used for detection may include a hand classifier, and the processor may classify the detected hand regions as at least one of a left-hand region, a right-hand region, and a both-hand region by using the hand classifier.

Thereafter, the processor may recognize 3D motion information from the person sub-image including the detected person region, the hand sub-images including the detected hand regions, and the face sub-image including the detected face region in step S1330.

For example, the processor may recognize body motion information from the person sub-image including the person region by using a second machine learning model, may recognize hand motion information from the hand sub-images including the hand regions by using a third machine learning model, and may recognize face motion information from the face sub-image including the face region by using a fourth machine learning model.

According to one embodiment, the second machine learning model used for body motion information recognition may be a model configured to output body model parameters and camera parameters based on a person sub-image. The body motion information may include body 3D joint angle information, body 3D joint location information, and body 3D mesh information, and at least some of these pieces of information may be obtained based on the body model parameters output by the second machine learning model.

Additionally, the second machine learning model may be a model configured to further output body 2D joint estimation information and a body part segmentation map based on a person sub-image. In this embodiment, the processor may classify the detected hand regions as at least one of a left-hand region, a right-hand region, and a both-hand region by using the body 3D joint location information, the body 2D joint estimation information, and the body part segmentation map.

Additionally or alternatively, the processor may simultaneously perform detection (in step S1320) and body motion information recognition by using the same machine learning model. For example, the first machine learning model may be a model configured to detect a person region, hand regions, and a face region from at least some of an input image and recognize body motion information. The processor may simultaneously perform detection (in step S1320) and body motion information recognition by using the first machine learning model configured as described above.

According to one embodiment, the third machine learning model used for recognizing hand motion information may be a model configured to output hand pose parameters based on the hand sub-images. The hand motion information may include first wrist angle information, hand 3D joint angle information, hand 3D mesh information, and camera parameters. At least some of these pieces of information may be obtained based on the hand pose parameters output by the third machine learning model.

According to one embodiment, the body motion information may include the second wrist angle information, elbow angle information, and shoulder angle information obtained based on the output of the second machine learning model. In this embodiment, the processor may correct the second wrist angle information, elbow angle information, and shoulder angle information (e.g., the information obtained based on the output of the second machine learning model) included in the body motion information by using the first wrist angle information obtained based on the hand pose parameters.

In one embodiment, the third machine learning model used for recognizing hand motion information may include a hand classifier. In this case, the processor may classify the detected hand regions as at least one of a left-hand region, a right-hand region, and a both-hand region by using the hand classifier included in the third machine learning model.

According to one embodiment, the fourth machine learning model used for recognizing face motion information may be a model configured to output 3D face model parameters, 3D facial landmark information, a blend shape, and camera parameters based on a face sub-image. The face motion information may include head pose information, face shape information, and face expression information. At least some of these pieces of information may be obtained based on the output of the fourth machine learning model. In one embodiment, when the processor recognizes face motion information based on a face sub-image by using the fourth machine learning model, the processor may recognize head pose information, face shape information, and face expression information separately. In this case, the face expression information may include gaze information and tongue movement information.

In one embodiment, the body motion information may include head angle information obtained based on the output of the second machine learning model. In this embodiment, the processor may correct the head angle information (the head angle information obtained based on the output of the second machine learning model) included in the body motion information by using the head pose information included in the face motion information (for example, the head pose information obtained based on the output of the fourth machine learning model).

According to one embodiment, the 3D motion information (the body motion information, the hand motion information, and the face motion information) may include joint angle information. The processor may correct the joint angle information included in the 3D motion information by using at least one of the body ratio of the person object included in the input image, the body ratio of the character, and the joint angle restriction information associated with the character.

Based on the 3D motion information recognized (and/or corrected) through the above-described method, rendering may be performed, and accordingly, a character image including a character that imitates the body motion, hand motion, and face motion of the person object included in the input image may be generated.

According to one embodiment, in the reception step S1310, the processor may sequentially receive a plurality of frame images including a person object. That is, the processor may sequentially receive a series of images (a video). In response to the sequential reception of each of the plurality of frame images, the processor may perform the above-described motion recognition (e.g., detection (in step S1320) and recognition (in step S1330)) in real time for each of the plurality of frame images. Accordingly, there may be generated a series of character images (i.e., a character video) including a character that imitates the motion (the body motion, hand motion, and face motion) of the person object included in the series of images (i.e., a video).

In an embodiment in which a plurality of frame images are sequentially received in this manner, when the processor simultaneously performs detection (in step S1320) and body motion information recognition by using the first machine learning model, the input to the first machine learning model may be determined based on detection results from a previous frame image. For example, in order to perform detection and body motion information recognition for a specific frame image, at least some of the specific frame image may be applied as the input to the first machine learning model. In this case, an image applied as the input to the first machine learning model may be determined based on whether a person region is detected from the previous frame image. When a person region is detected from the previous frame image, at least some of the specific frame image applied as the input to the first machine learning model may include a region at the same location as the person region detected from the previous frame image. In contrast, when a person region is not detected from the previous frame image, the overall specific frame image may be applied as the input to the first machine learning model.

The flowchart of FIG. 13 and the above description are only one embodiment of the present disclosure, and may be implemented in other manners. For example, in some embodiments, one or more steps may be added/deleted/changed, or the order of the individual steps may be changed.

The above-described method may be provided as a computer program stored on a computer-readable recording medium for the purpose of execution on a computer. The medium may be a medium that continuously stores a computer-executable program or temporarily stores a computer-executable program for the purpose of execution or download. Furthermore, the medium may be a variety of recording means or storage means in the form of a single piece of hardware or in the form of multiple pieces of hardware combined. The medium may not be limited to a medium directly connected to a computer system, but may also be distributed over a network. Examples of the medium may include magnetic media such as a hard disk, a floppy disk and a magnetic tape, optical storage media such as CD-ROM and a DVD, magneto-optical media such as a floptical disk, ROM, RAM, and flash memory, and may be configured to store program instructions. Furthermore, other examples of the medium may include recording media or storage media that are managed by app stores that distribute applications or by other sites, servers, etc. that supply or distribute various pieces of software.

The methods, operations, or techniques of the present disclosure may be implemented by various means. For example, these techniques may be implemented as hardware, firmware, software, or a combination thereof. It will be appreciated by those skilled in the art that the various exemplary logical blocks, modules, circuits, and algorithm steps described in connection with the disclosure of the present application may be implemented as electronic hardware, computer software, or combinations of both. To clearly illustrate this interchangeability of hardware and software, various exemplary components, blocks, modules, circuits, and steps have been described above generally in terms of their functionality. Whether such functionality is implemented as hardware or software will depend upon the design requirements imposed on a particular application and an overall system. It will be appreciated that those skilled in the art may implement the described functionality in a variety of ways for each particular application, but such implementations should not be construed as causing a departure from the scope of the present disclosure. Those skilled in the art may implement the described functionality in various manners for each particular application, but such implementations should not be construed as departing from the scope of the present disclosure.

In hardware implementations, the processing units used to perform the techniques may be implemented within one or more ASICs, DSPs, digital signal processing devices (DSPDs), programmable logic devices (PLDs), field programmable gate arrays (FPGAs), processors, controllers, microcontrollers, microprocessors, electronic devices, other electronic units designed to perform the functions described herein, a computer, or a combination thereof.

Accordingly, the various exemplary logic blocks, modules, and circuits described in connection with the present disclosure may be implemented or performed by any combination of a general-purpose processor, a DSP, an ASIC, an FPGA or other programmable logic device, a discrete gate or transistor logic, discrete hardware components, or those designed to perform the functions described herein. The general-purpose processor may be a microprocessor, but as an alternative, the processor may be any conventional processor, controller, microcontroller, or state machine. The processor may also be implemented as a combination of computing devices, such as a combination of a DSP and a microprocessor, a plurality of microprocessors, one or more microprocessors in conjunction with a DSP core, or any other configuration.

In firmware and/or software implementations, the techniques may be implemented as instructions stored on a computer-readable medium, such as random access memory (RAM), read-only memory (ROM), non-volatile random access memory (NVRAM), programmable read-only memory (PROM), erasable programmable read-only memory (EPROM), electrically erasable PROM (EEPROM), flash memory, a compact disk (CD), or a magnetic or optical data storage device. The instructions may be executable by one or more processors and may cause the processor(s) to perform the specific aspects of the functionality described in the present disclosure.

When implemented as software, the techniques may be stored on or transmitted via a computer-readable medium as one or more instructions or code. The computer-readable medium includes both a computer storage medium and a communication medium, including any medium that facilitates the transmission of a computer program from one place to another. The storage medium may be any available medium that can be accessed by a computer. By way of non-limiting example, the computer-readable medium may include RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Furthermore, any connection is appropriately termed a computer-readable medium.

For example, when the software is transmitted from a website, a server, or another remote source by using a coaxial cable, a fiber optic cable, a twisted pair, a digital subscriber line (DSL), or a wireless technology such as an infrared, radio, or microwave technology, the coaxial cable, the fiber optic cable, the twisted pair, the digital subscriber line, or the wireless technology such as the infrared, radio, or microwave technology are included within the definition of the medium. The disk or disc used herein includes a compact disc, a laser disc, an optical disc, a digital versatile disc (DVD), a floppy disk, and a Blu-ray disc. In this case, the disks generally reproduce data magnetically, while the discs reproduce data optically by using lasers. The above combinations should also be included within the range of computer-readable media.

The software module may reside in RAM memory, flash memory, ROM memory, EPROM memory, EEPROM memory, registers, a hard disk, a removable disk, a CD-ROM, or any other form of storage medium known in the art. The exemplary storage medium may be connected to a processor so that the processor can read information from the storage medium or write information to the storage medium. Alternatively, the storage medium may be integrated with the processor. The processor and the storage medium may reside within an ASIC. The ASIC may reside within a user terminal. Alternatively, the processor and the storage medium may be present as discrete components in a user terminal.

While the embodiments described above have been described as utilizing the aspects of the presently disclosed subject matter in one or more standalone computer systems, the present disclosure is not limited thereto, and may be implemented in conjunction with any computing environment, such as a network or distributed computing environment. Furthermore, in the present disclosure, the aspects of subject matter may be implemented in a plurality of processing chips or devices, and storage may be similarly affected across a plurality of devices. These devices may include PCs, network servers, and mobile devices.

Although the present disclosure has been described in connection with some embodiments herein, various modifications and changes may be made without departing from the scope of the present disclosure as understood by those skilled in the art to which the invention of the present disclosure pertains. In addition, such modifications and changes should be considered to fall within the scope of the claims appended to the present specification.

1. A 3D motion capture method, the 3D motion capture method being performed by at least one processor, the 3D motion capture method comprising:
receiving an input image including a person object;
detecting a person region, hand regions, and a face region from at least some of the input image by using a first machine learning model; and
recognizing 3D motion information from a person sub-image including the person region, hand sub-images including the hand regions, and a face sub-image including the face region;
wherein a character image, including a character that imitates a body motion, hand motion, and face motion of the person object included in the input image, is generated through rendering based on the 3D motion information.

2. The 3D motion capture method of claim 1, wherein:
the receiving an input image comprises sequentially receiving a plurality of frame images including the person object;
in response to sequential reception of each of the plurality of frame images, the detecting and the recognizing are performed in real time for each of the plurality of frame images; and
a plurality of character images, each including a character that imitates a body motion, hand motion, and face motion of the person object included in a corresponding one of the plurality of frame images, are generated through rendering based on the 3D motion information.

3. The 3D motion capture method of claim 1, wherein:
the first machine learning model comprises a hand classifier; and
the detecting comprises classifying the detected hand regions as at least one of a left-hand region, a right-hand region, and a both-hand region by using the hand classifier.

4. The 3D motion capture method of claim 1, wherein the recognizing comprises:
recognizing body motion information from the person sub-image including the person region by using a second machine learning model;
recognizing hand motion information from the hand sub-images including the hand regions by using a third machine learning model; and
recognizing face motion information from the face sub-image including the face region by using a fourth machine learning model.

5. The 3D motion capture method of claim 4, wherein:
the second machine learning model is a model configured to output body model parameters and camera parameters based on the person sub-image; and
the body motion information comprises body 3D joint angle information, body 3D joint location information, and body 3D mesh information obtained based on the body model parameters.

6. The 3D motion capture method of claim 5, wherein the second machine learning model is a model further configured to further output body 2D joint estimation information and a body part segmentation map based on the person sub-image.

7. The 3D motion capture method of claim 6, further comprising classifying the detected hand regions as at least one of a left-hand region, a right-hand region, and a both-hand region by using the body 3D joint location information, the body 2D joint estimation information, and the body part segmentation map.

8. The 3D motion capture method of claim 4, wherein:
the first machine learning model is a model configured to detect the person region, the hand regions, and the face region from at least some of the input image and recognize the body motion information; and
the second machine learning model is the same model as the first machine learning model.

9. The 3D motion capture method of claim 8, wherein:
receiving the input image comprises sequentially receiving a plurality of frame images having the same size;
in response to sequential reception of each of the plurality of frame images, the detecting and the recognizing 3D motion information are performed in real time for each of the plurality of frame images;
in the detecting and the recognizing 3D motion information for a specific one of the plurality of frame images, at least some of the specific frame image is applied as input to the first machine learning model; and
the at least some of the specific frame image applied as input to the first machine learning model:
when a person region is detected from a previous frame image of the specific frame image, includes a region at a location that is the same as a location of the person region detected from the previous frame image; and
when a person region is not detected from a previous frame image of the specific frame image, is all the specific frame image.

10. The 3D motion capture method of claim 4, wherein:
the third machine learning model comprises a hand classifier; and
the recognizing hand motion information comprises classifying the detected hand regions as at least one of a left-hand region, a right-hand region, and a both-hand region by using the hand classifier.

11. The 3D motion capture method of claim 4, wherein:
the third machine learning model is a model configured to output hand pose parameters based on the hand sub-images; and
the hand motion information comprises first wrist angle information, hand 3D joint angle information, hand 3D mesh information, and camera parameters obtained based on the hand pose parameters.

12. The 3D motion capture method of claim 11, wherein:
the body motion information comprises second wrist angle information obtained based on an output of the second machine learning model; and
the recognizing 3D motion information further comprises correcting the second wrist angle information obtained based on the output of the second machine learning model by using the first wrist angle information obtained based on the hand pose parameters.

13. The 3D motion capture method of claim 11, wherein:
the body motion information comprises elbow angle information and shoulder angle information obtained based on an output of the second machine learning model; and
the recognizing 3D motion information further comprises correcting the elbow angle information and shoulder angle information obtained based on the output of the second machine learning model by using the first wrist angle information.

14. The 3D motion capture method of claim 4, wherein the fourth machine learning model is a model configured to output 3D face model parameters, 3D facial landmark information, a blend shape, and camera parameters based on the face sub-image.

15. The 3D motion capture method of claim 4, wherein:
the face motion information comprises head pose information, face shape information, and face expression information; and
the recognizing face motion information comprises recognizing the head pose information, the face shape information, and the face expression information separately from the face sub-image by using the fourth machine learning model.

16. The 3D motion capture method of claim 15, wherein the face expression information comprises gaze information and tongue movement information.

17. The 3D motion capture method of claim 15, wherein:
the body motion information comprises head angle information obtained based on an output of the second machine learning model; and
the recognizing 3D motion information further comprises correcting the head angle information obtained based on the output of the second machine learning model by using the head pose information.

18. The 3D motion capture method of claim 1, wherein:
the 3D motion information comprises joint angle information; and
the recognizing 3D motion information comprises correcting the joint angle information by using at least one of a body ratio of the person object included in the input image, a body ratio of the character, and joint angle restriction information associated with the character.

19. A computer-readable non-transitory storage medium having recorded thereon instructions for executing the method according to claim 1 on a computer.

20. A motion capture system comprising:
memory; and
at least one processor connected to the memory and configured to execute at least one computer-readable program included in the memory;
wherein the at least one program comprises instructions for receiving an input image including a person object, detecting a person region, hand regions, and a face region from at least some of the input image by using a first machine learning model, and recognizing 3D motion information from a person sub-image including the person region, hand sub-images including the hand regions, and a face sub-image including the face region; and
wherein a character image, including a character that imitates a body motion, hand motion, and face motion of the person object included in the input image, is generated through rendering based on the 3D motion information.
